(19) United States
(12) Patent Application Publication
(10) Pub. No.: US 2008/0228459 A1
(43) Pub. Date: Sep. 18, 2008

(54) Method and Apparatus for Performing Capacity Planning and Resource Optimization in a Distributed System

(75) Inventors: Guofei Jiang, Princeton, NJ (US); Haifeng Chen, Old Bridge, NJ (US); Kenji Yoshihira, Cranford, NJ (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 11/860,610

(22) Filed: Sep. 25, 2007

Related U.S. Application Data
(60) Provisional application No. 60/829,186, filed on Oct. 12, 2006.

(51) Int. Cl. G06F 15/173; G06F 9/455

(52) U.S. Cl. 703/13; 709/226

(57) ABSTRACT

Disclosed is a method and apparatus for performing capacity planning and resource optimization in a distributed system. In particular, the capacity needs of individual components (e.g., server, operating system, CPU, application software, memory, networking device, storage device, etc.) in a distributed system can be analyzed using relationships between measurements collected from the distributed system. These relationships, called invariants, do not change over time. From these measurements, a network of invariants are determined. The network of invariants characterize the relationships between the measurements. The capacity need of at least one component in the distributed system can be determined from the network of invariants.

This application claims the benefit of U.S. Provisional Application No. 60/829,186 filed on Oct. 12, 2006, which is incorporated herein by reference.

### BACKGROUND OF THE INVENTION

The present invention is related generally to distributed systems, and in particular to capacity planning and resource optimization in distributed systems.

A company having a presence on the Internet typically provides a single website for a user to view and for performing transactions. Although users may only see a single website, typically large-scale distributed systems are running the services provided by the website. A large-scale distributed system is a system that contains multiple (e.g., thousands) components such as servers, operating systems, central processing units (CPUs), memory, application software, networking devices and storage devices. These large-scale distributed systems can often process a large volume of transaction requests simultaneously. For example, a large Internet search site may have thousands of servers to handle millions of user queries every day.

Clients expect a high quality of service (QoS), such as short latency and high availability, from online transaction services. Clients may easily become dissatisfied due to unreliable services or even seconds of delay in response time. As a result of the dynamics and uncertainties of user loads and behaviors, some components of a distributed system may become a performance bottleneck and deteriorate system QoS. These problems are typically the result of poor capacity planning for one or more components in a distributed system. Therefore, it is desirable to perform correct capacity planning for each component in order to maintain acceptable QoS for the system for any user load.

Capacity planning and resource (i.e., component) optimization is often a balancing act. On one hand, sufficient hardware resources have to be deployed so as to meet customers' QoS expectations. On the other hand, an oversized, scalable system could waste hardware resources, increase information technology (IT) costs, and reduce profits. For distributed systems, it is typically important to balance resources across distributed components to achieve maximum system level capacity. Otherwise, mismatched component capacities can lead to performance bottlenecks at some segments of the system while wasting resources at other segments. Therefore, it is typically difficult to precisely and systematically analyze the capacity needs for individual components in a distributed system.

Typically, planners implement many procedures while planning capacity of components of a distributed system. These procedures are often the result of a trial and error strategy for matching component capacities in a distributed system. Planners usually assign resources based on their intuition, practical experiences, or rules of thumb. For example, planners may have ten servers as part of a distributed system for handling user transactions associated with a web page. The installation of the ten servers may be based on previous experiences with similar types of web pages. If the web page crashes or cannot handle the number of user requests, then the system is likely overloaded and the users may become dissatisfied. The planners may subsequently address this issue by adding one additional server to the system and seeing if that solves the problem. Planners may continue to add additional servers until the problem is solved. Additional crashes may further aggravate users. Also, one server out of the original ten servers may be the culprit because the server may be overloaded (e.g., the database server may not be able to handle the number of database reads associated with the number of user requests) and adding additional servers to the entire system may, in fact, only waste resources.

Therefore, there remains a need to systematically and precisely analyze the capacity needs for individual components in a distributed system.

### BRIEF SUMMARY OF THE INVENTION

The capacity needs of the components of a distributed system are typically dependent on the volume of users that request the services. Over time, when the number of customers change (e.g., user volumes are much higher during a holiday sale season), capacity planning may have to periodically be redone to upgrade the system capacity so as to match new user needs.

In accordance with an embodiment of the present invention, the capacity needs of individual components (e.g., server, operating system, CPU, application software, memory, networking device, storage device, etc.) in a distributed system are analyzed using relationships between measurements collected from the distributed system. These relationships, called invariants, do not change over time. From these measurements, a network of invariants are determined. The network of invariants characterizes the relationships between the measurements. The capacity needs of the components in a distributed system are determined from the network of invariants.

In one embodiment, component use in the system is optimized by comparing the estimated capacity need of the component with current component assignments.

In one embodiment, the measurements are flow intensity measurements. A flow intensity is the intensity with which internal measurements react to the volume of user loads. Invariants can then be automatically extracted from these flow intensity measurements. This may include generating a plurality of models, where each model is generated from at least two measurements. A fitness score can then be calculated for each model by testing how well the model approximates the measurements. A model may be discarded when the model performs less than desirable (e.g., less than a fitness score). In one embodiment, a confidence score is then determined for each node in the network of invariants. A confidence score measures the robustness of an invariant and can be used to determine the capacity needs of a component. Once the capacity needs of components are determined, the resources of the system can be optimized.

These and other advantages of the invention will be apparent to those of ordinary skill in the art by reference to the following detailed description and the accompanying drawings.

### BRIEF DESCRIPTION OF THE DRAWINGS

FIG. 1 is a block diagram of a client in communication with a distributed system having a capacity planning module;

FIG. 2 shows a high level flowchart illustrating steps performed by the capacity planning module to determine the capacity requirements of components in the distributed system;

FIG. 3 shows graphs of the intensities of HTTP requests and SQL queries, respectively, collected from a three-tier web system such as the distributed system of FIG. 1;

FIG. 4 is a block diagram of a network of invariants in accordance with an embodiment of the present invention;

FIG. 5A shows a flowchart illustrating additional details of steps performed to extract invariants;

FIG. 5B shows pseudo code of an invariant extraction algorithm;

FIG. 6 shows a block diagram of an invariant network;

FIG. 7A shows a flowchart to determine the capacity needs of one or more components of a distributed system;

FIG. 7B shows pseudo code of an algorithm to determine the capacity needs of one or more components of a distributed system;

FIG. 8A is a flowchart illustrating steps performed to optimize resources based on the capacity needs of components;

FIG. 8B is pseudo code of a resource optimization algorithm;

FIG. 9 shows a graph of a system response with overshoot; and

FIG. 10 shows a high level block diagram of a computer system which may be used in an embodiment of the invention.

### DETAILED DESCRIPTION

For standalone software, people often use fixed numbers to specify the hardware requirements of a system executing the software, such as the CPU frequency and memory size. It is difficult, however, to obtain such specifications for online services because their system requirements are mainly determined by an external factor—the volume of user loads. In accordance with an embodiment of the present invention, a model or function rather than a fixed number is used to analyze the capacity needs of each component of a distributed system. Although models such as queuing models are conventionally applied in performance modeling, these models are often used to analyze a limited number of components under various assumptions (e.g., in a Queuing model, there are several assumptions that are made, such as that workloads follow specific distributions such as Poisson distributions and it also has to be stationary). Such assumptions cannot be made when determining capacity needs of components in a distributed system.

During operation, distributed systems traditionally generate large amounts of monitoring data to track their operational status. In accordance with an embodiment of the present invention, this monitoring data is collected from various components of a distributed system. CPU usage, network traffic volume, and number of SQL queries are examples of monitoring data that may be collected.

### System Invariants and Capacity Planning

While a large volume of user requests flow through various components in a system, many resource consumption related measurements respond to the intensity of user loads accordingly. Flow intensity as used herein refers to the intensity with which internal measurements respond to the volume of (i.e., number of) user loads. Then, constant relationships between flow intensities are determined at various points across the system. If such relationships always hold under various workloads over time, they are referred to herein as invariants of the distributed system. In one embodiment, a computer automatically searches for and extracts these invariants. After extracting many invariants from a distributed system, given any volume of user loads, the invariant relationships can be followed sequentially to estimate the capacity needs of individual components. By comparing the current resource assignments against the estimated capacity needs, the weakest points of the system that may deteriorate system performance can be located and ranked. Operators can use such analytical results to optimize resource assignments and remove potential performance bottlenecks.

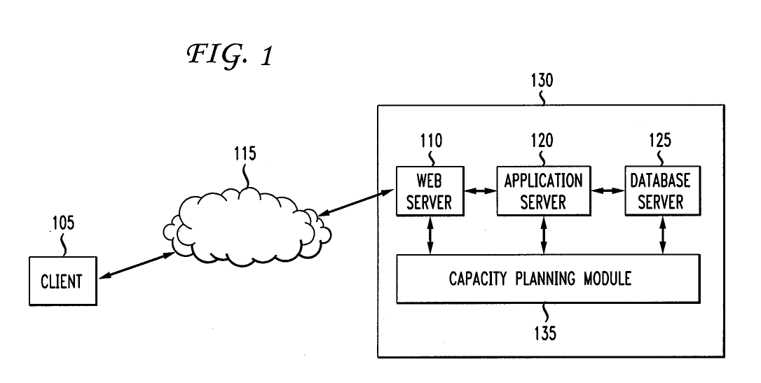

FIG. 1 shows a block diagram of an embodiment of a client 105 in communication with a web server 110 over a network 115. For example, the client 105 may be viewing a web page provided by the web server 110 over the network 115. The web server 110 is additionally in communication with one or more other servers and components, such as an application server 120, a database server 125, and one or more databases (not shown). These servers 110, 120, 125 form a distributed system 130 used to generate and manage the web page and transactions associated with the web page.

Although shown with one web server 110, one application server 120, and one database server 125, any number of these servers 110, 120, 125 may be included in the distributed system 130. The distributed system 130 also includes a capacity planning module 135 to determine the resources needed for the distributed system 130. The capacity planning module 135 may be part of one of the servers 110, 120, 125 or may execute on its own server.

Capacity planning can be applied to many other distributed systems besides the 3-tier system shown in FIG. 1. Thus, the 3-tier system is an example of a general distributed system.

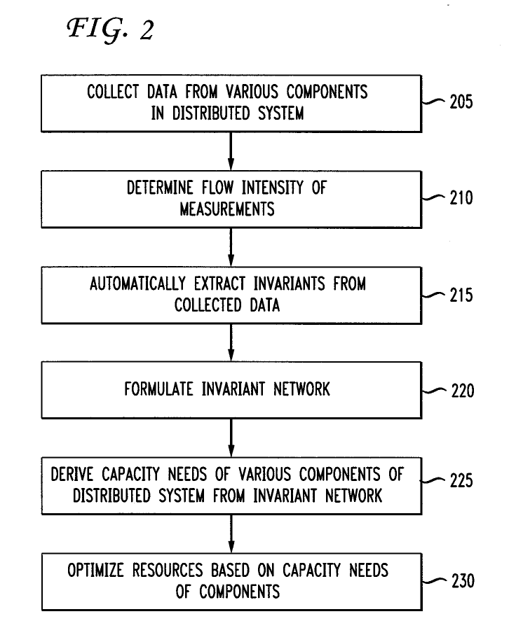

FIG. 2 shows a high level flowchart illustrating the steps performed by the capacity planning module 135 to determine the capacity requirements of components in distributed system 130. The capacity planning module 135 collects data from various components (e.g., the web server 110 and application server 120) in the distributed system 130 in step 205. In particular, distributed system 130 typically generates large amounts of monitoring data such as log files to track their operational status.

In step 210, the capacity planning module 135 determines flow intensity measurements from the collected data. For online services, while a large volume of user requests flow through various components according to their application logics, many of the internal measurements respond to the intensity of user loads accordingly. For example, network traffic volume and CPU usage usually vary in accordance with the volume of user requests. This is especially true of many resource consumption related measurements because they are mainly driven by the intensity of user loads. As described above, flow intensity is used herein to measure the intensity with which such internal measurements react to the volume of user requests. For example, the number of SQL queries and average CPU usage (per sampling unit) are such flow intensity measurements.

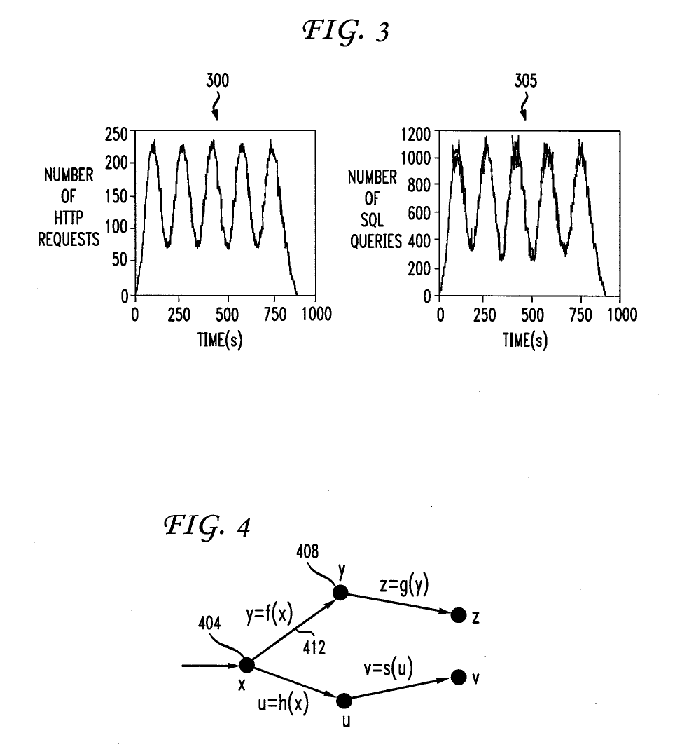

Strong correlations typically exist between these flow intensity measurements. If these flow intensity measurements are graphed over time, the graphs may be similar because the measurements mainly respond to the same external factor—the volume of user requests. FIG. 3 shows graphs 300, 305 of the intensities of HTTP requests and SQL queries, respectively, collected from a three-tier web system such as distributed system 130. The curves of graphs 300 and 305 are similar. A distributed system such as system 130 imposes many constraints on the relationships among these internal measurements. Such constraints could result from many factors such as hardware capacity, application software logic, system architecture, and functionality.

For example, in a web system, if a specific HTTP request x always leads to two related SQL queries y, the function I(y)=2I(x) should always be accurate because the instructions causing two SQL queries to occur is written in the system's application software. Note that here I(x) and I(y) are used to represent the flow intensities measured at the point x and y respectively. No matter how flow intensities I(x) and I(y) change in accordance with varying user loads, such relationships I(y)=2I(x) are always constant. These constant relationships between measurements are referred to herein as invariants of the underlying system. Note that the relationship I(y)=2I(x) (but not the measurements) is considered as an invariant.

In step 215, such invariants are automatically extracted from the measurements collected at various locations across the distributed system 130. These invariants characterize the constant relationships between various flow intensity measurements.

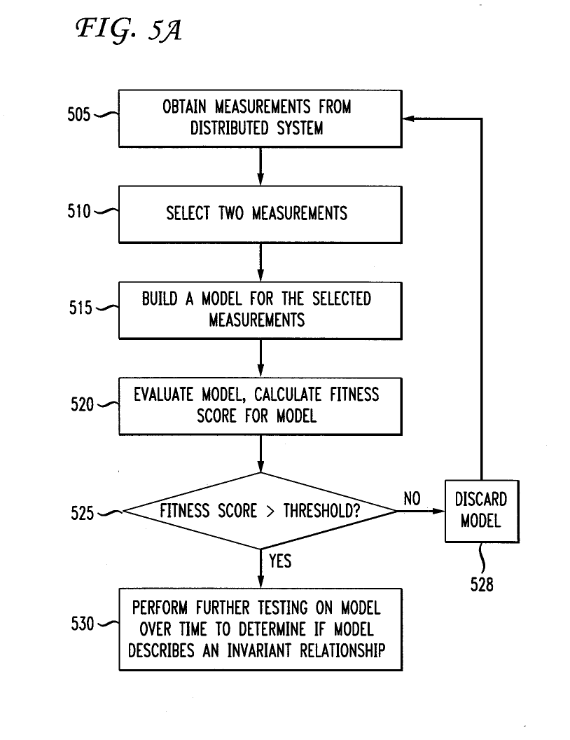

A network of invariants is then formulated in step 220. An example of such a network is shown in FIG. 4. In this network, each node (e.g., nodes 404 and 408) represents a measurement while each edge (e.g., edge 412) represents an invariant relationship (e.g., y=f(x)) between the two associated measurements. As described in further detail below, the invariant network can be used to profile services for capacity planning and resource optimization.

Since the validity of invariants is not affected by the change of user loads, in one embodiment the volume of user requests is selected as the starting node and the edges in the invariant network are sequentially followed to determine the capacity needs of various components of the distributed system in step 225. The volume of user requests (the starting point) may be predicted based on historical workloads and trend analysis. In the above example, if the predicted number of HTTP requests is I(x₁), the invariant relationship I(y)=2I(x) can be used to conclude that the resulting number of SQL queries is 2I(x₁).

The capacity needs of components are quantitatively represented by these resource consumption related measurements. For example, given a maximum of user loads, a server may be required to have two 1 GHz CPUs, 4 GB of memory, and 100 MB/s network bandwidth, etc. These numbers can be derived from the expected usage of CPU, memory, and network bandwidth under this load, respectively. By comparing the current resource assignments against the estimated capacity needs, the weakest points that may become performance bottlenecks may be discovered. Thus, the capacity needs of various components of the system can be used to optimize the resources of the distributed system (step 230). Therefore, given any volume of user loads, operators can use such a network of invariants to estimate capacity needs of various components, balance resource assignments, and remove potential performance bottlenecks.

### Correlation of Flow Intensities

With flow intensities measured at various points across systems, modeling the relationships between these measurements is important. That is, with measurements x and y, determining a function f to obtain y=f(x) is important. As described above, many of the resource consumption related measurements change in accordance with the volume of user requests. As time series, these measurements likely have similar evolving curves along time t. Therefore, the assumption is made that many of the measurements have linear relationships. In one embodiment, autoregressive models with exogenous inputs (ARX) are used to determine linear relationships between measurements.

At time t, the flow intensities measured at the input and output of a component are denoted by x(t) and y(t) respectively. The ARX model describes the following relationship between two flow intensities:

y(t)+a₁y(t−1)+ . . . +aₙy(t−n)=b₀x(t−k)+ . . . +bₘ₋₁x(t−k−m−1)+bₘ (1)

where [n, m, k] is the order of the model and the model determines how many previous steps are affecting the current output. aᵢ and bⱼ are the coefficient parameters that reflect how strongly a previous step is affecting the current output. Let's denote:

θ=[a₁, . . . , aₙ, b₀, . . . , bₘ]^{T}, (2)

φ(t)=[−y(t−1), . . . , −y(t−n), x(t−k), . . . x(t−k−m−1),1]^{T}, (3)

Then Equation (1) can be rewritten as:

y(t)=φ(t)^{T}θ. (4)

Assuming that two measurements have been observed over a time interval 1≦t≦N, lets denote this observation by:

O_{N}={x(1), y(1), . . . x(N), y(N)}, (5)

For a given 0, the observed inputs x(t) can be used to calculate the simulated outputs ŷ(t|θ0) according to Equation (1). Thus, the simulated outputs can be compared with the observed outputs to further define the estimation error by:

$$\begin{matrix}{E}_{N} ( θ , {O}_{N} ) = \frac{1}{N} {\sum }_{t = 1}^{N} ( y ( t ) - {\hat{y} ( t \vert θ ) )}^{2} \\ = \frac{1}{N} {\sum }_{t = 1}^{N} {( y ( t ) - {ϕ ( t )}^{T} θ )}^{2} .\end{matrix} \qquad ( 6 )$$

The Least Squares Method (LSM) can find the following 0 that minimizes the estimation error E_{N}(θ, O_{N}):

$${\hat{θ}}_{N} = {[ {\sum }_{t = 1}^{N} ϕ ( t ) {ϕ ( t )}^{T} ]}^{- 1} {\sum }_{t = 1}^{N} ϕ ( t ) y ( t ) . \qquad ( 7 )$$

There are several criteria to evaluate how well the determined model fits the real observation. In one embodiment, the following equation is used to calculate a normalized fitness score for model validation:

$$F ( θ ) = [ 1 - \sqrt{\frac{{\sum }_{t = 1}^{N} \vert y ( t ) - \hat{y} ( t \vert θ ) {\vert}^{2}}{{\sum }_{t = 1}^{N} {\vert y ( t ) - \overline{y} \vert}^{2}}} ] \qquad ( 8 )$$

where y̅ is the mean of the real output y(t). Equation (8) introduces a metric to evaluate how well the determined model approximates the real data. A higher fitness score indicates that the model fits the observed data better and its upper bound is 1. Given the observation of two flow intensities, Equation (7) can be used to determine a model even if this model does not reflect their real relationship. Therefore, a model with a high fitness score is meaningful in characterizing a data relationship. A range of the order [n, m, k] can be set rather than a fixed number to determine a list of model candidates. A model with the highest fitness score can then be selected. Other criteria such as minimum description length (MDL) can also be used to select models. Note that the ARX model can be used to determine the long-run relationship between two measurements, i.e., a model y=f(x) captures the main characteristics of their relationship. The precise relationship between two measurements can be represented with y=f(x)+E where E is a modeling error. Note that E is usually small for a model with a high fitness score.

### Extracting Invariants

Given two measurements, the above description illustrated how to automatically determine a model. In practice, many resource consumption related measurements may be collected from a complex system but pairs of them may not have linear relationships. Due to system dynamics and uncertainties, some determined models may not be robust over time.

In more detail about step 215 of FIG. 2, and in one embodiment, to extract invariants from a large number of measurements, some relationships may be built from prior system knowledge. In another embodiment, an algorithm to automatically search and extract invariants from measurements can be used.

Note that for capacity planning purposes, invariants are searched among resource consumption related measurements. Assume m measurements denoted by Iᵢ, 1≦i≦m. In one embodiment, a brute force search is performed to construct all hypotheses of invariants first and then sequentially test the validity of these hypotheses in operation (because there is sufficient monitoring data from an operational system to validate these hypotheses). The fitness score Fₖ(θ) given by Equation (8) can be used to evaluate how well a determined model matches the data observed during the k^{th} time window. The length of this window is denoted by I, i.e., each window includes/sampling points of measurements. As described above, given two measurements, Equation (7) may also be used to determine a model. However, models with low fitness scores do not characterize the real data relationships well so that a threshold \tilde{F} is chosen to filter out those models in sequential testings. Denote the set of valid models at time t=k·l by Mₖ (i.e., after k time windows). During the sequential testings, once F_{K}(θ)≦\tilde{F}, the testing of this model is stopped and it is removed from Mₖ.

After receiving monitoring data for k of such windows, i.e., total k·l sampling points, a confidence score can be calculated with the following equation:

$${p}_{k} ( θ ) = \frac{{\sum }_{i = 1}^{k} {F}_{i} ( θ )}{k} = \frac{{p}_{k - 1} ( θ ) \cdot ( k - 1 ) + {F}_{k} ( θ )}{k} . \qquad ( 9 )$$

In fact, Pₖ(θ) is the average fitness score for k time windows. Since the set Mₖ only includes valid models, we have Fᵢ(θ)>\tilde{F}(1≦i≦k) and \tilde{F}<pₖ(θ)≦1.

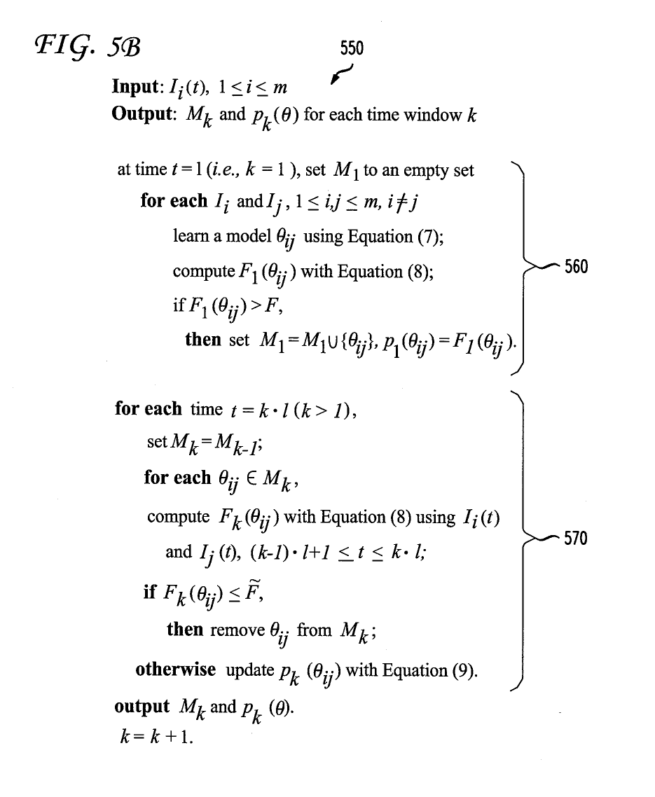

FIG. 5A shows a flowchart illustrating additional details of an algorithm to extract invariants (as initially described above with respect to step 215 of FIG. 2). The capacity planning module 135 obtains measurements from the various components of the distributed system 130 in step 505. In one embodiment, the capacity planning module 135 obtains measurements periodically. Alternatively, the capacity planning module 135 may obtain measurements after a predetermined time period has elapsed, a set number of times, after an action or event has occurred, etc. The capacity planning module 135 then selects every two measurements from the obtained measurements in step 510. In one embodiment, this selection is a random selection. In another embodiment, the selection is predetermined (e.g., select the first and second measurements first, the first and third measurements second, etc. It is a brute-force search so that we learn a model for every pair of two measurements). In step 515, the capacity planning module 135 builds a model for the selected measurements and then evaluates the model with new observations in step 520. A fitness score is also calculated for the model in step 520. It is then determined whether the fitness score is greater than a threshold in step 525. If not, the model is discarded in step 528. If the fitness score is greater than the threshold in step 525, further testing is performed on the model over time to determine if the model describes an invariant relationship in step 530. For example, further testing may be performed for a set number of data points or for a set time period.

FIG. 5B shows pseudo code 550 illustrating an embodiment of the invariant extraction algorithm of FIG. 5A. As described above, the algorithm 550 determines a model for any two measurements (using Equation (7) above) in block 560 and then incrementally validates these models with new observations. At each step, each model is evaluated to determine how well each model fits the monitoring data collected during the new time window. If a model's fitness score is lower than the threshold, this model is removed from the set of invariant candidates subject to further testings (block 570).

In one embodiment, the invariants extracted with algorithm 550 are considered to be likely invariants. As described above, a model can be regarded as an invariant of the underlying system if the model remains fixed over time. However, even if the validity of a model has been sequentially tested for a long time (e.g., a predetermined amount of time, such as several days), this does not guarantee that this model will always hold. Therefore, it is more accurate to consider these valid models as likely invariants. Based on historical monitoring data, each confidence score pₖ(θ) can measure the robustness of an invariant. Note that given two measurements, logically it is unknown which measurement should be chosen as the input or output (i.e., x or y in Equation (1)) in complex systems. Therefore, in one embodiment two models with reverse input and output are constructed. If two determined models have different fitness scores, an AutoRegressive (AR) model was constructed rather than an ARX model. Since strong correlation between two measurements is of interest, those AR models are filtered by requesting the fitness scores of both models to overpass the threshold. Therefore, in one embodiment an invariant relationship between two measurements is bi-directional.

Additional details of flow intensity and the extraction of invariants are described in patent application Ser. No. 11/275,796, titled “Automated Modeling and Tracking of Transaction Flow Dynamics for Fault Detection in Complex Systems” and patent application Ser. No. 11/685,805, titled “Method and System for Modeling Likely Invariants in Distributed Systems” both of which are incorporated herein by reference.

### Estimation of Capacity Needs

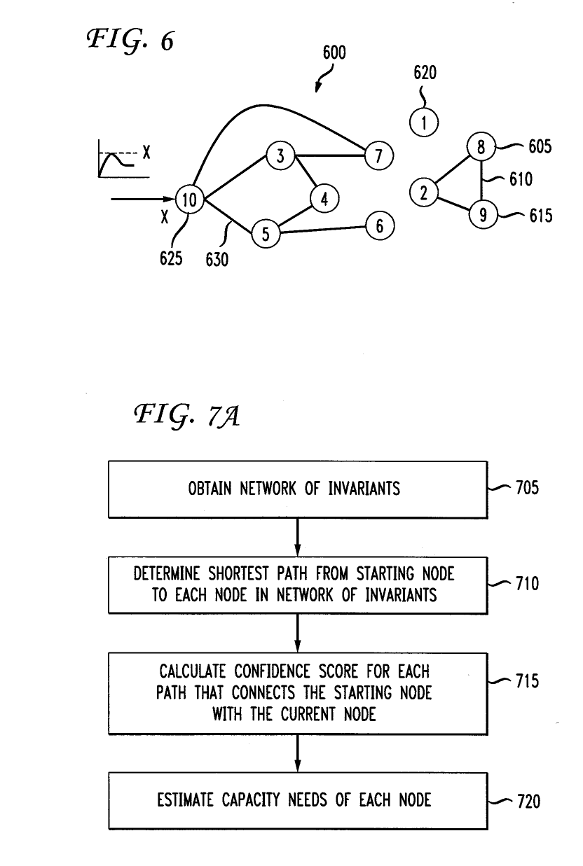

As described above, algorithm 550 automatically searches and extracts possible invariants among the measurements Iᵢ, 1≦i≦m. Further, these measurements and invariants formulate a relation network that can be used as a model to systematically profile services. Under a low volume of user requests, a network of invariants is determined from a system when the quality of its services meets clients' expectations. Thus, in one embodiment a system may be profiled when the system is in a predetermined state. Assume that ten resource consumption related measurements have been collected (i.e., m=10) from system 130 and further algorithm 550 extracts an invariant network 600 as shown in FIG. 6 from these measurements. In this network 600, each node (e.g., node 605) with number i represents the measurement I, while each edge (e.g., edge 610) represents an invariant relationship between two associated measurements (e.g., represented by nodes 605 and 615).

As a threshold \tilde{F} may be used to filter out those models with low fitness scores, some pairs of measurements do not have invariant relationships. For example, two disconnected subnetworks and isolated nodes such as node 1 620 are present. An isolated node implies that this measurement does not have any linear relationship with other measurements. The edges are bi-directional because two models are constructed (with reverse input and output) between the two measurements.

Consider a triangle relationship among three measurements {I₁₀, I₃, I₄}. Assume I₃=f(I₁₀) and I₄=g(I₃), where f and g are both linear functions as shown in Equation (1). Based on the triangle relationship, it may be determined that I₄=g(I₃)=g(f(I₁₀)). Accordingly to linear properties of functions f and g, the function g(f(.)) should be linear too, which implies that there should exist an invariant relationship between the measurements I₁₀ and I₄. Since a threshold is used to filter out those models with low fitness scores, due to modeling errors, such a linear relationship may not be robust enough to be considered as an invariant. This explains why there is no edge between I₁₀ and I₄.

As described above, invariants characterize constant long-run relationships between measurements and their validity is not affected by the dynamics of user loads over time if the underlying system operates normally. While each invariant models some local relationship between its associated measurements, the network of invariants may capture many invariant constraints underlying the whole distributed system. Rather than using one or several analytical models to profile services, many invariant models are combined into a network to analyze capacity needs and optimize resource assignments. In practice, trend analysis or other statistical methods may be used to predict the volume of user requests.

Assume that at time t (e.g., in a month or during a sales event), the maximum volume of user requests is predicted to increase to x. In FIG. 6, the measurement I₁₀ (represented by node 625) is used to represent the volume of user requests, i.e., I₁₀=x.

The capacity of other nodes in the network 600 are upgraded so as to serve this volume of user requests. Note that the capacity needs of system components are quantitatively specified with resource consumption related measurements. For example, network bandwidth (bits/second) can be used to specify a network's capacity.

Starting from the node 625 (i.e., I₁₀=x), edges (e.g., edge 630) are sequentially followed to estimate the capacity needs of other nodes in the invariant network 600. The nodes {I₃, I₅, I₇} can be reached with one hop. Given I₁₀=x, the question is how to follow invariants to estimate these measurements. As described above, in one embodiment the model shown in Equation (1) is used to search invariant relationships between measurements so that all invariants can be considered as instances of this model template. According to the linear property of the models, the capacity needs of system components increase monotonically as the volume of user loads increases. Therefore, in one embodiment, although user loads go up and down randomly, the maximum value of user loads is used in the capacity analysis. Here x is used to denote the maximum value of I₁₀. In Equation (1), if the inputs x(t) are set to x at all time steps, the output y(t) is expected to converge to a constant value y(t)=y, where y can be derived from the following equations:

$$y + {a}_{1} y + ... + {a}_{n} y = {b}_{0} x + ... + {b}_{m - 1} x + {b}_{m} , \\ y = \frac{{\sum }_{i = 0}^{m - 1} {b}_{i} x + {b}_{m}}{1 + {\sum }_{j = 1}^{n} {a}_{j}} . \qquad ( 10 )$$

In one embodiment, f(θᵢⱼ) is used to represent the propagation function from Iᵢ to Iⱼ, i.e.,

$$f ( {θ}_{ij} ) = \frac{{\sum }_{k = 0}^{m - 1} {b}_{k} {I}_{i} + {b}_{m}}{1 + {\sum }_{k = 1}^{n} {a}_{k}}$$

where all coefficient parameters are from the vector Oᵢⱼ, as shown in Equation (2).

Based on Equation (10), given an input x, the output y can be uniquely determined by the coefficient parameters of invariants. According to the linear properties of invariants, y is the maximum value of the output measurement if x is the maximum value of input. Therefore, given a value of the input measurement, Equation (10) can be used to estimate the value of the output measurement. For example, given I₁₀=x, invariants can be used to derive the values of I₃, I₅, and I₇. Since these measurements are the inputs of other invariants, their values can similarly be propagated to other nodes in the network, such as the nodes I₄ and I₆.

As shown in FIG. 6, some nodes such as I₄ and I₇ can be reached from the starting node I₁₀ via multiple paths. Between the same two nodes, multiple paths may include a different number of edges and each invariant (edge) also may have a different quality in modeling two nodes' relationship. Therefore, the capacity needs of a node can be estimated via different paths with different accuracy. For each node, the question is how to locate the best path for propagating the volume of user loads from the starting node. In one embodiment, the shortest path (i.e., with minimum number of hops) is chosen to propagate this value. As discussed above, each invariant may include some modeling error E when it characterizes the relationship between two measurements. These modeling errors can accumulate along a path and a longer path usually results in a larger estimation error. The confidence score pₖ(θ) can be used to measure the robustness of invariants. According to the definition of confidence score, an invariant with a higher fitness score may result in better accuracy for capacity estimation. In one embodiment, Pᵢⱼ is used to represent the pₖ(θ) between the measurements Iᵢ and Iⱼ, pᵢⱼ is set to 0 when there is no relationship between Iᵢ and Iⱼ. Given a specific path s, an accumulated score qₛ=πpᵢⱼ can be derived to evaluate the accuracy of this whole path. Therefore, for multiple paths including the same number of edges, the path with the highest score qₛ is chosen to estimate capacity needs.

Additionally, some nodes are not reachable from the starting node. These measurements, however, may still have linear relationships with a set of other nodes because they may have a similar but nonlinear or stochastic way to respond to user loads. In performance modeling, models such as queuing models (e.g., following laws such as a utilization law, service demand law and/or the forced flow law, etc.) have been developed to characterize individual components. Following these laws and classic theory, nonlinear or stochastic models can be manually built to link those measurements in disconnected subnetworks (though they may not have linear relationships as shown in Equation (1)). In other embodiments, bound analysis is used to derive rough relationships between measurements. Therefore, in one embodiment the volume of user loads can be propagated to these isolated nodes.

For example, if any two nodes can be manually bridged from the two disconnected subnetworks, the volume of user loads can be propagated several hops further. Even in this case, the extracted invariant network may still be useful because it can provide guidance on where to bridge between two disconnected subnetworks. For example, it is usually easier to build models among measurements from the same individual component because system dependency is more straightforward in this local context. Rather than building models across distributed systems, some local models can be manually built to link disconnected subnetworks. In one embodiment, such complicated models are considered to be another class of invariants from system knowledge and are not distinguished.

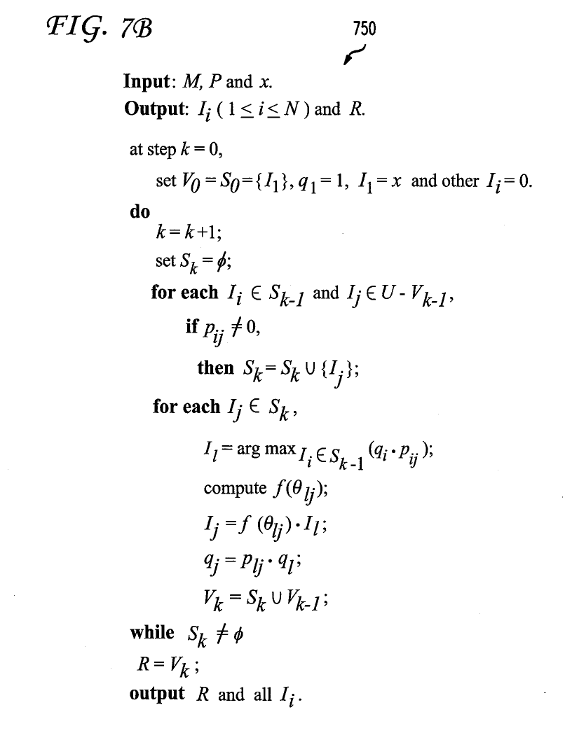

In more detail of step 225 of FIG. 2, FIG. 7A shows a flowchart to determine the capacity needs of one or more components of distributed system 130. A network of invariants is obtained from the extracted invariants as described above (step 705). In step 710, the shortest path from the starting node to each node in the network of invariants is determined. If there are several shortest paths, a confidence score is then determined for each path that connects the starting node with the current node in step 715, and the capacity needs of each node (i.e., component) is determined by the best path with the highest confidence score in step 720. In particular, the relationship accumulated along this best path (e.g., if y=f(x) and x=g(z), then y=g (f(z)), where z is the starting point here) is used to estimate capacity needs under a given workload. The confidence score can judge the quality of the path, but typically cannot be used to calculate capacity needs. The functions along the path are used to calculate the capacity needs propagation.

FIG. 7B shows pseudo code of an algorithm 750 to determine the capacity needs of one or more components of a distributed system. The algorithm in FIG. 7B is pseudo code of the steps shown in FIG. 7A. The following variables are defined for algorithm 750:
Iᵢ: the individual measurements 1≦i≦N.
U: the set of all measurements, i.e., U=Iᵢ.
M: the set of all invariants, i.e., M={θᵢⱼ} where θᵢⱼ is the invariant model between the measurements Iᵢ and Iⱼ.
Pᵢⱼ: the confidence score of the model θᵢⱼ. Note that pᵢⱼ=0 if there is no invariant (edge) between the measurements Iᵢ and Iⱼ.
P: the set of all confidence scores, i.e., P {P=pᵢⱼ}.
x: the predicted maximum volume of user loads.
I₁: the starting node in the invariant network, i.e., I₁=x.
Sₖ: the set of nodes that are only reachable at the k^{th} hop from I₁ but not at earlier hops.
Vₖ: the set of all nodes that have been visited up to the k^{th} hop.
R: the set of all nodes that are reachable from Iᵢ.
φ: the empty set.
f(θᵢⱼ): the propagation function from Iᵢ to Iⱼ.
qₛ: the maximum accumulated confidence score of the best path from the starting node I₁ to Iₛ.

As described above with respect to FIG. 5, algorithm 550 automatically extracts robust invariants after sequential testing phases. As shown in FIG. 7B, algorithm 750 follows the extracted invariant network specified by M and P to estimate capacity needs. Since the shortest path to propagate from the starting node to other nodes may be chosen, at each step algorithm 750 only searches those unvisited nodes for further propagation and all those nodes visited before this step already have their shortest paths to the starting node. Further, algorithm 750 uses those newly visited nodes at each step to search for their next hop because only these newly visited nodes may link to some unvisited nodes. For those nodes with multiple same-length paths to the starting node, in one embodiment the best path with the highest accumulated confidence score is selected for estimating the capacity needs. Thus, algorithm 750 is a graph algorithm based on dynamic programming. The capacity needs of those newly visited nodes are incrementally estimated and their accumulated confidence scores are computed at each step until no further nodes are reachable from the starting node.

### Resource Optimization

As described above, algorithm 750 sequentially estimates those resource consumption related measurements that are driven by a given volume of user loads. These measurements can be further used to evaluate the capacity needs of their related components in distributed systems. For large scale distributed systems with many (e.g., thousands of) servers, it is typically critical to plan component capacity correctly and to optimize resource assignments. Due to the dynamics and uncertainties of user loads, a system without enough capacity could deteriorate system performance and result in user dissatisfaction. Conversely, an “oversized” system may waste resources and increase IT costs. For large distributed systems, one challenge is how to match the capacities of various components inside the system to remove potential performance bottlenecks and achieve maximum system level capacity. Mismatched capacities of system components may result in performance bottlenecks at one segment of a system while wasting resources at other segments.

Assume that the information about current resource configurations of a distributed system has been collected. For example, this information may have been recorded when the system was deployed or upgraded. For each measurement Iᵢ, the related resource configuration can be denoted by Cᵢ. In one embodiment, this configuration information includes hardware specifications like memory size as well as software configurations such as the maximum number of database connections. Given a volume of user loads x, algorithm 750 can be used to estimate the values of Iᵢ. Here, it is assumed that all measurements Iᵢ (1≦i≦N) are reachable from the starting node. If they are not reachable from the starting node, then those unreachable measurements are removed from capacity analysis, i.e., remove Iᵢ if Iᵢ∉R. By comparing Iᵢ against Cᵢ, information about potential performance bottlenecks may be located and resource assignments may be balanced.

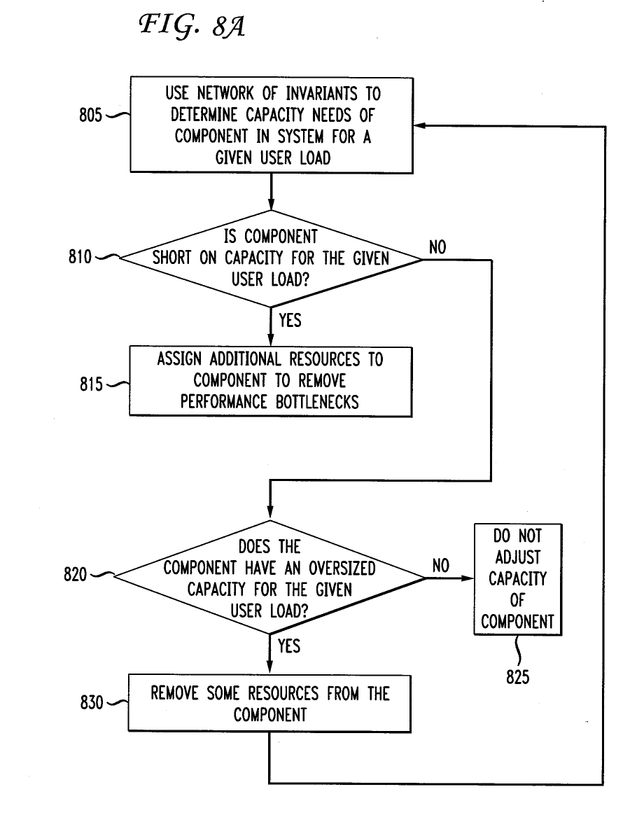

FIG. 8A shows further details of step 230 of FIG. 2 and is a flowchart illustrating the steps performed to optimize resources based on the capacity needs of components. As described above (FIGS. 7A and 7B), the network of invariants is used to determine capacity needs of components in the system for a given user load (step 805). The capacity planning module 135 then determines whether a component is short on capacity for the given user load in step 810. If a component is short on capacity for a given user load, additional resources can be assigned to the component to remove performance bottlenecks in step 815.

If a component is not short on capacity for a given user load in step 810, it is then determined whether the component has an oversized capacity for the given user load in step 820. If not, then the capacity of the component is not adjusted (step 825). If so, then some resources are removed from the component in step 830.

FIG. 8B is pseudo code illustrating a resource optimization algorithm 850 in accordance with an embodiment of the present invention. In algorithm 850,

$${O}_{i} = \frac{{C}_{i} - {I}_{i}}{C} ,$$

where Oᵢ represents the percentage of resource shortage or available margin. Given a volume of user loads, the components with negative Oᵢ are short in capacity and can be assigned more resources to remove performance bottlenecks. Conversely, for components with positive Oᵢ, the components have oversized capacities to serve such volume of user loads and some resources may be removed from these components to reduce IT costs. In algorithm 850, the values of Oᵢ are sorted to list the priority of resource assignments and optimization.

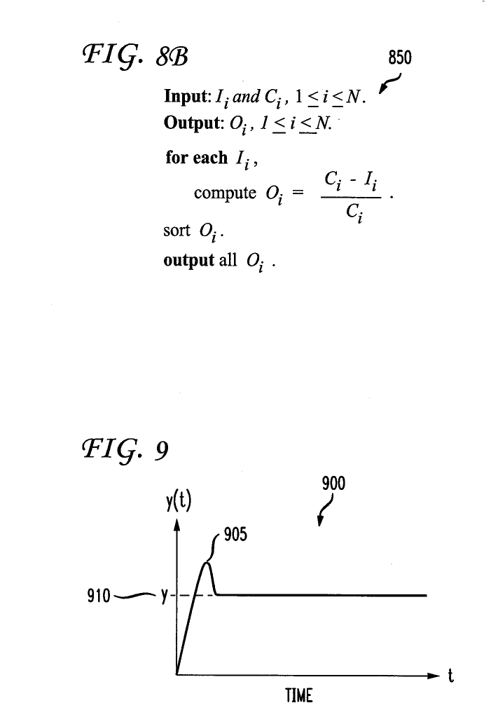

Note that the maximum volume of user loads x are propagated through the invariant network for estimating capacity needs. All Iᵢ resulting from algorithm 750 represent the capacity needs of various components to serve this maximum volume of user loads. Given a step input x(t)=x, its stable output y(t)=y is derived using Equation (10). However, the transient response of y(t) has not been considered before it converges to the stable value y. FIG. 9 shows a graph 900 of a system response with overshoot 905 above a reference value y 910. As shown, theoretically y(t) may respond with overshoot 905 and its transient value may be larger than the stable value y 910. The overshoot 905 is generated because a system component does not respond quickly enough to the sudden change of user loads. For example, in a three-tier web system, with a sudden increase of user loads, the application server may take some time to initialize more Enterprise JavaBeans (EJB) instances and create more database connections. During this overshoot period, longer latency of user requests may be observed.

Unlike mechanical systems, computing systems usually respond to the dynamics of user loads quickly. Therefore, even if the overshoot exists, it typically only lasts a short time. In many instances, no overshoot responses can be observed. In one embodiment, to ensure a system has enough capacity to handle overshoots, the volume of overshoots can be calculated and these overshoot values can be propagated rather than the stable y to estimate capacity needs. For low order ARX models with n, m≦2, classic control theory can be used to calculate the overshoot. For high order ARX models, given an input x(t)=x, in one embodiment the transient response y(t) can be simulated and the overshoot can be estimated using Equation (1). At each step of algorithm 750, rather than using the function f(θᵢⱼ) to estimate a stable Iⱼ, simulation results can be used to estimate transient Iᵢ and further propagate the overshoot value to estimate capacity needs of other nodes. All other parts of algorithm 750 remain the same.

### Computer Implementation

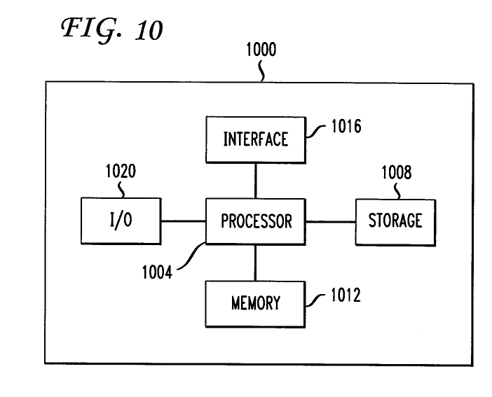

The description herein describes the present invention in terms of the processing steps required to implement an embodiment of the invention. These steps may be performed by an appropriately programmed computer, the configuration of which is well known in the art. An appropriate computer may be implemented, for example, using well known computer processors, memory units, storage devices, computer software, and other modules. A high level block diagram of such a computer is shown in FIG. 10. Computer 1000 contains a processor 1004 which controls the overall operation of computer 1000 by executing computer program instructions which define such operation. The computer program instructions may be stored in a storage device 1008 (e.g., magnetic disk) and loaded into memory 1012 when execution of the computer program instructions is desired. Computer 1000 also includes one or more interfaces 1016 for communicating with other devices (e.g., locally or via a network). Computer 1000 also includes input/output 1020 which represents devices which allow for user interaction with the computer 1000 (e.g., display, keyboard, mouse, speakers, buttons, etc.). The computer 1000 may represent the capacity planning module and/or may execute the algorithms described above.

One skilled in the art will recognize that an implementation of an actual computer will contain other elements as well, and that FIG. 10 is a high level representation of some of the elements of such a computer for illustrative purposes. In addition, one skilled in the art will recognize that the processing steps described herein may also be implemented using dedicated hardware, the circuitry of which is configured specifically for implementing such processing steps. Alternatively, the processing steps may be implemented using various combinations of hardware and software. Also, the processing steps may take place in a computer or may be part of a larger machine.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for determining a capacity need of at least one component in a distributed system comprising:
determining, from collected measurements, a network of invariants characterizing relationships between said measurements; and
determining the capacity need of said at least one component from said network of invariants.

2. The method of claim 1 further comprising optimizing component use in said distributed system by comparing said capacity need of said at least one component with current component assignments.

3. The method of claim 1 wherein said at least one component further comprises at least one of an operating system, application software, a central processing unit (CPU), memory, a server, a networking device, and a storage device.

4. The method of claim 1 further comprising:
collecting said measurements from various components in said distributed system.

5. The method of claim 1 wherein said measurements are flow intensity measurements.

6. The method of claim 1 further comprising automatically extracting invariants from said measurements.

7. The method of claim 6 wherein said automatically extracting further comprises generating a model from at least two measurements in said measurements.

8. The method of claim 7 further comprising calculating a fitness score for said model by testing how well said model approximates said measurements.

9. The method of claim 8 further comprising eliminating said model as a likely invariant when said fitness score is less than a threshold.

10. The method of claim 7 wherein said model is an autoregressive model with exogenous inputs (ARX).

11. The method of claim 1 further comprising calculating a confidence score for each path in said network of invariants.

12. Apparatus for determining a capacity need of at least one component in a distributed system comprising:
means for determining, from collected measurements, a network of invariants characterizing relationships between said measurements; and
means for determining the capacity need of said at least one component from said network of invariants.

13. The apparatus of claim 12 further comprising means for optimizing component use in said distributed system by comparing said capacity need of said at least one component with current component assignments.

14. The apparatus of claim 12 wherein said at least one component further comprises at least one of an operating system, application software, a central processing unit (CPU), memory, a server, a networking device, and a storage device.

15. The apparatus of claim 12 further comprising means for collecting said measurements from various components in said distributed system.

16. The apparatus of claim 12 further comprising means for automatically extracting invariants from said measurements.

17. The apparatus of claim 16 further comprising means for generating a model from at least two measurements in said measurements.

18. The apparatus of claim 17 further comprising means for calculating a fitness score for said model by testing how well said model approximates said measurements.

19. The apparatus of claim 18 further comprising means for eliminating said model as a likely invariant when said fitness score is less than a threshold.

20. The apparatus of claim 12 further comprising means for calculating a confidence score for each path in said network of invariants.

21. A computer readable medium comprising computer program instructions capable of being executed in a processor and defining the steps comprising:
determining, from measurements collected from a distributed system, a network of invariants characterizing relationships between said measurements; and
determining a capacity need of at least one component in said distributed system from said network of invariants.

22. The computer readable medium of claim 21 further comprising computer program instructions defining the step of optimizing component use in said distributed system by comparing said capacity need of said at least one component with current component assignments.

23. The computer readable medium of claim 21 wherein said at least one component further comprises at least one of an operating system, application software, a central processing unit (CPU), memory, a server, a networking device, and a storage device.

24. The computer readable medium of claim 21 further comprising computer program instructions defining the step of collecting said measurements from various components in said distributed system.

25. The computer readable medium of claim 21 further comprising computer program instructions defining the step of automatically extracting invariants from said measurements.
